(19) United States
(12) Patent Application Publication
(10) Pub. No.: US 2013/0257758 A1
(43) Pub. Date: Oct. 3, 2013

(54) TOUCH-SENSITIVE ELECTRONIC DEIVCE AND METHOD OF CONTROLLING SAME

(71) Applicant: HON HAI PRECISION INDUSTRY CO., LTD., New Taipei (TW)

(72) Inventor: FU-KUO HUANG, New Taipei (TW)

(73) Assignee: HON HAI PRECISION INDUSTRY CO., LTD., New Taipei (TW)

(21) Appl. No.: 13/688,405

(22) Filed: Nov. 29, 2012

(30) Foreign Application Priority Data
Mar. 30, 2012 (TW) 101111602

(51) Int. Cl. G06F 3/041

(52) U.S. Cl. CPC G06F 3/041
USPC 345/173

(57) ABSTRACT

An electronic device includes a fingerprint sensor, a touch-sensitive display, and a processor operably coupled to the fingerprint sensor and the touch-sensitive display. The fingerprint sensor recognizes a fingerprint of a finger of a user. The touch-sensitive display detects a touch gesture made by the finger. The processor controls the electronic device to perform an action associated with a combination of the fingerprint and the touch gesture. A method of controlling the electronic device is also provided.

### REFERENCE TO RELATED APPLICATIONS

This application claims all benefits accruing under 35 U.S.C. §119 from Taiwan Patent Application No. 101111602, filed on Mar. 30, 2012 in the Taiwan Intellectual Property Office. The contents of the Taiwan Application are hereby incorporated by reference.

### BACKGROUND

1. Technical Field

The disclosure generally relates to electronic devices, and particularly relates to touch-sensitive electronic devices and methods of controlling the touch-sensitive electronic devices.

2. Description of Related Art

Touch-sensitive displays (also known as “touch screens” or “touchscreens”) are well known in the art. Touch screens are used in many electronic devices to display graphics and text, and to provide a user interface through which a user may interact with the devices. A touch screen of an electronic device may detect and respond to touch gestures made with the touch screen. The electronic device may perform certain actions associated with the detected touch gestures. However, the use of the touch gestures by itself cannot provide sufficiently high security for the electronic device.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of an electronic device in accordance with one embodiment.

FIG. 2 is a flowchart showing one embodiment of a method of controlling the electronic device of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

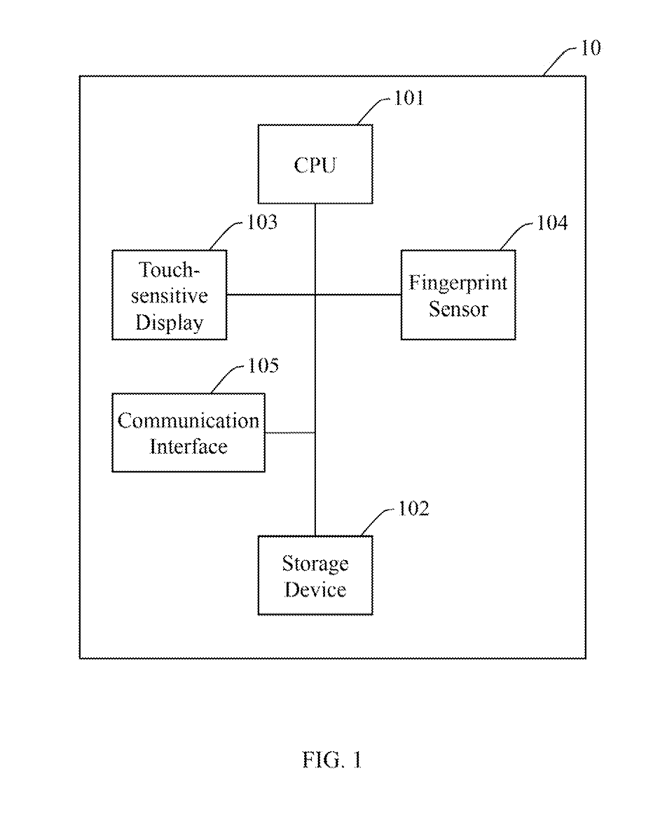

FIG. 1 shows an electronic device 10 in accordance with one embodiment. The electronic device 10 includes a central processing unit (CPU) 101, a storage device 102, a touch-sensitive display 103, and a fingerprint sensor 104. The electronic device 10 may be a smartphone, a personal digital assistant (PDA), or a tablet computer.

The CPU 101 is operably coupled to the storage device 102, the touch-sensitive display 103, and the fingerprint sensor 104. The CPU 101 may include one or more processors that provide the processing capability to execute the operating system, programs, user and application interfaces, and any other functions of the electronic device 10. The CPU 101 may include one or more microprocessors and/or related chip sets. For example, the CPU 101 may include “general purpose” microprocessors, a combination of general and special purpose microprocessors, instruction set processors, graphics processors, video processors, related chips sets, and/or special purpose microprocessors. The CPU 101 also may include on board memory for caching purposes.

Information, such as programs and/or instructions, used by the CPU 101 may be located within the storage device 102. The storage device 102 may store a variety of information and may be used for various purposes. For example, the storage device 102 may store firmware for the electronic device 10 (such as a basic input/output instruction or operating system instructions), various programs, applications, or routines executed on the electronic device 10, user interface functions, processor functions, and so forth. In addition, the storage device 102 may be used for buffering or caching during operation of the electronic device 10.

The storage device 102 may include any suitable manufacture that includes one or more tangible, computer-readable media. For example, the storage device 102 may include a volatile memory, such as random access memory (RAM), and/or as a non-volatile memory, such as read-only memory (ROM). The components may further include other forms of computer-readable media, such as non-volatile storage, for persistent storage of data and/or instructions. The non-volatile storage may include flash memory, a hard drive, or any other optical, magnetic, and/or solid-state storage media. The non-volatile storage may be used to store firmware, data files, software, wireless connection information, and any other suitable data.

The touch-sensitive display 103 may provide both an output interface and an input interface between the electronic device 10 and a user. The touch-sensitive display 103 may display visual output to the user. The visual output may include text, graphics, video, and any combination thereof.

The touch-sensitive display 103 may also accept input from the user based on haptic and/or tactile contact. The touch-sensitive display 103 forms a touch-sensitive surface that accepts user input. The touch-sensitive display 103 may detect contact (and any movement or break of the contact) on the touch-sensitive display 103 and convert the detected contact into interaction with user-interface objects, such as one or more soft keys, that are displayed on the touch-sensitive display 103. In an exemplary embodiment, a point of contact between the touch-sensitive display 103 and the user corresponds to one or more digits of the user. The touch-sensitive display 103 may use LCD (liquid crystal display) technology, or LPD (light emitting polymer display) technology, although other display technologies may be used in other embodiments. The touch-sensitive display 103 may detect contact and any movement or break thereof using any of a plurality of touch sensitivity technologies, including but not limited to capacitive, resistive, infrared, and surface acoustic wave technologies, as well as other proximity sensor arrays or other elements for determining one or more points of contact with the touch-sensitive display 103. The user may make contact with the touch-sensitive display 103 using any suitable object or appendage, such as a stylus, finger, and so forth.

The fingerprint sensor 104 may capture and recognize one or more fingerprints of the user. The one or more recognized fingerprints may be compared with one or more pre-stored fingerprints to determine whether the user is a specific user, such as an authorized user.

The communication interface 105 may provide connectivity channels for receiving and transmitting information and/or for connecting to other electronic devices. The communication interface 105 may represent, for example, a network interface card (NIC) or a network controller. The communication interface 105 may include a local area network (LAN) interface for connecting to a wired Ethernet-based network and/or a wireless LAN, such as an IEEE 802.11x wireless network.

The communication interface 105 also may include a wide area network (WAN) interface that permits connection to the Internet via a cellular data network, such as the Enhanced Data rates for GMS Evolution (EDGE) network or a 3G or 4G network. Further, the communication interface 105 may include a personal area network (PAN) interface for connecting to a BLUETOOTH® network, an IEE 802.15.4 (Zig-Bee) network, or an ultra-wideband network (UWB). The communication interface 105 may include any number and combination of network interfaces. As will be appreciated, the communication interface 105 may employ one or more protocols, such as the High-Speed Downlink Packet Access (HSDPA) protocol, for rapidly downloading data over a network.

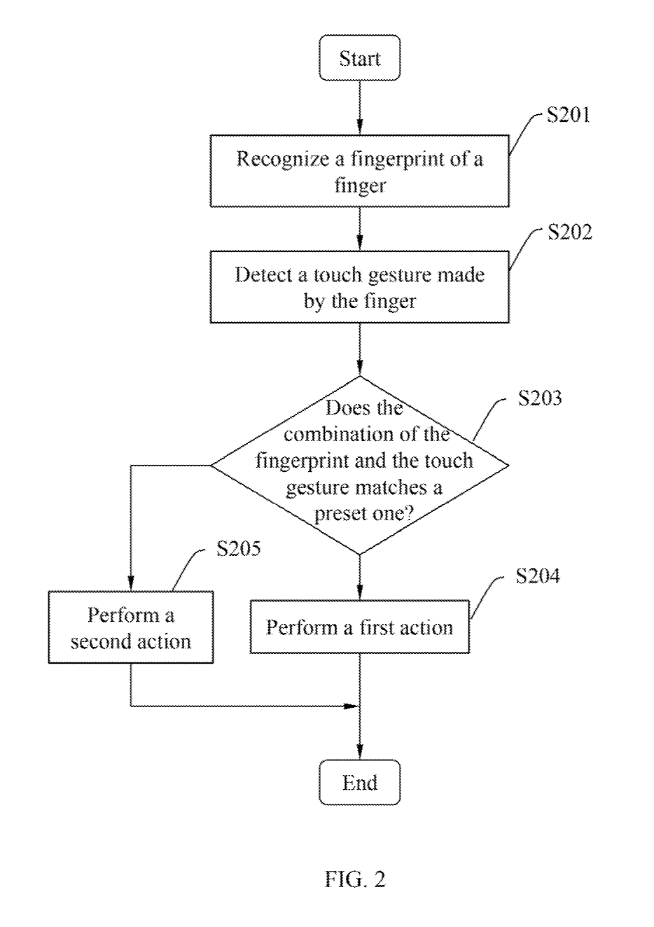

FIG. 2 is a flowchart showing one embodiment of a method of controlling the electronic device 10. The method comprises the following steps.

In step S201, the fingerprint sensor 104 recognizes a fingerprint of a finger of the user.

In step S202, the touch-sensitive display 103 detects a touch gesture made by the finger with the touch-sensitive surface of the touch-sensitive display 103.

In step S203, the CPU 101 determines whether the combination of the recognized fingerprint and detected the touch gesture matches a combination of a predefined fingerprint and a predefined touch gesture. The predefined touch gesture is a movement of a point of contact across the touch-sensitive surface of the touch-sensitive display 103 while maintaining continuous contact with the touch-sensitive surface of the touch-sensitive display 103. In some embodiments, the movement of the point of contact across the touch-sensitive surface of the touch-sensitive display 103 while maintaining continuous contact with the touch-sensitive surface of the touch-sensitive display 103 can be a horizontal movement.

If the combination of the recognized fingerprint and detected the touch gesture matches the combination of the predefined fingerprint and the predefined touch gesture, the flow goes to step S204; otherwise, the flow goes to step S205.

In step S204, the CPU 101 controls the electronic device to perform a first action associated with the combination of the recognized fingerprint and the detected touch gesture. In some embodiments, the first action is an unlocking action. Namely, the CPU 101 transitions the electronic device 10 to a user-interface unlocked state in response to the determination that the combination of the recognized fingerprint and the detected touch gesture matches the combination of the predefined fingerprint and the predefined touch gesture.

In step S205, the CPU 101 controls the electronic device to perform a second action distinct from the first action. In some embodiments, the second action is a locking maintaining action. Namely, the CPU 101 maintains the electronic device 10 in a user-interface locked state in response to the determination that the combination of the recognized fingerprint and the detected touch gesture does not match the combination of the predefined fingerprint and the predefined touch gesture. While the electronic device 10 is in user-interface lock state, the electronic device 10 is prevented from performing a predefined set of actions, such as logging into a private system and obtaining specific data.

In some embodiments, the fingerprint sensor 104 is integrated within the touch-sensitive display 103. The fingerprint sensor 104 uses the touch-sensitive surface of the touch-sensitive display 103 to sense fingerprints of the user. As such, the touch-sensitive surface of the touch-sensitive display 103 not only may detect the touch gesture made by the user, but also may capture and recognize the fingerprint of a finger, which contacts the touch-sensitive surface of the touch-sensitive display 103. In these embodiments, the step S201 and the step S202 are performed at the same time. That is, the fingerprint sensor 104 is recognizing the fingerprint of the finger while the touch-sensitive display 103 is detecting the touch gesture made by the finger.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An electronic device, comprising:
a fingerprint sensor configured to recognize a fingerprint of a finger of a user;
a touch-sensitive display configured to detect a touch gesture made by the finger; and
a processor operably coupled to the fingerprint sensor and the touch-sensitive display, the processor being configured to control the electronic device to perform an action associated with a combination of the fingerprint and the touch gesture.

2. The electronic device of claim 1, wherein the processor is further configured:
to determine whether the combination of the fingerprint and the touch gesture matches a combination of a predefined fingerprint and a predefined touch gesture;
to transition the electronic device to a user-interface unlocked state in response to a determination that the combination of the fingerprint and the touch gesture matches the combination of the predefined fingerprint and the predefined touch gesture; and
to maintain the electronic device in a user-interface lock state in response to a determination that the combination of the fingerprint and the touch gesture does not match the combination of the predefined fingerprint and the predefined touch gesture.

3. The electronic device of claim 2, wherein the processor is further configured, while the electronic device is in user-interface lock state, to prevent the electronic device from performing a predefined set of actions in response to a determination that the combination of the fingerprint and the touch gesture does not match the combination of the predefined fingerprint and the predefined touch gesture.

4. The electronic device of claim 2, wherein the predefined touch gesture is a movement of a point of contact across the touch-sensitive display while maintaining continuous contact with the touch-sensitive display.

5. The electronic device of claim 4, wherein the movement of the point of contact across the touch-sensitive display while maintaining continuous contact with the touch-sensitive display is a horizontal movement.

6. The electronic device of claim 1, wherein the fingerprint sensor is integrated within the touch-sensitive display, and the fingerprint sensor is configured to recognize the fingerprint of the finger while the touch-sensitive display is detecting the touch gesture made by the finger.

7. An electronic device, comprising:
a touch-sensitive display;
a fingerprint sensor;
a storage device;
at least one processor; and
one or more programs stored in the storage device and configured for execution by the at least one processor, the one or more programs comprising instructions:
to recognize a fingerprint of a finger of a user;
to detect a touch gesture made by the finger with the touch-sensitive display; and
to control the electronic device to perform an action associated with a combination of the fingerprint and the touch gesture.

8. The electronic device of claim 7, wherein the one or more programs further comprise instructions:
to determine whether the combination of the fingerprint and the touch gesture matches a combination of a predefined fingerprint and a predefined touch gesture;
to transition the electronic device to a user-interface unlocked state in response to a determination that the combination of the fingerprint and the touch gesture matches the combination of the predefined fingerprint and the predefined touch gesture; and
to maintain the electronic device in a user-interface lock state in response to a determination that the combination of the fingerprint and the touch gesture does not match the combination of the predefined fingerprint and the predefined touch gesture.

9. The electronic device of claim 8, wherein the one or more programs further comprise instructions, while the electronic device is in user-interface lock state, to prevent the electronic device from performing a predefined set of actions in response to a determination that the combination of the fingerprint and the touch gesture does not match the combination of the predefined fingerprint and the predefined touch gesture.

10. The electronic device of claim 8, wherein the predefined touch gesture is a movement of a point of contact across the touch-sensitive display while maintaining continuous contact with the touch-sensitive display.

11. The electronic device of claim 10, wherein the movement of the point of contact across the touch-sensitive display while maintaining continuous contact with the touch-sensitive display is a horizontal movement.

12. The electronic device of claim 7, wherein the fingerprint sensor is integrated within the touch-sensitive display, and the one or more programs further comprises instructions to recognize the fingerprint while the touch gesture is being detected by the touch-sensitive display.

13. A method of controlling an electronic device, the method comprising:
recognizing a fingerprint of a finger of a user by a fingerprint sensor;
detecting a touch gesture made by the finger with a touch-sensitive display; and
controlling the electronic device to perform an action associated with a combination of the fingerprint and the touch gesture.

14. The method of claim 13, wherein the controlling of the electronic device further comprises:
determining whether the combination of the fingerprint and the touch gesture matches a combination of a predefined fingerprint and a predefined touch gesture;
transitioning the electronic device to a user-interface unlocked state in response to a determination that the combination of the fingerprint and the touch gesture matches the combination of the predefined fingerprint and the predefined touch gesture; and
maintaining the electronic device in a user-interface lock state in response to a determination that the combination of the fingerprint and the touch gesture does not match the combination of the predefined fingerprint and the predefined touch gesture.

15. The method of claim 14, the controlling of the electronic device further comprising, while the electronic device is in user-interface lock state, preventing the electronic device from performing a predefined set of actions in response to a determination that the combination of the fingerprint and the touch gesture does not match the combination of the predefined fingerprint and the predefined touch gesture.

16. The method of claim 14, wherein the predefined touch gesture is a movement of a point of contact across the touch-sensitive display while maintaining continuous contact with the touch-sensitive display.

17. The method of claim 16, wherein the movement of the point of contact across the touch-sensitive display while maintaining continuous contact with the touch-sensitive display is a horizontal movement.

18. The method of claim 13, wherein the steps of recognizing the fingerprint and detecting the touch gesture are performed simultaneously.
